(19) United States
(12) Patent Application Publication
(10) Pub. No.: US 2003/0222732 A1
(43) Pub. Date: Dec. 4, 2003

(54) Narrow-band filters with zig-zag hairpin resonator

(75) Inventor: George L. Matthaei, Santa Barbara, CA (US)

Correspondence Address: O'MELVENY & MEYERS, 114 PACIFICA, SUITE 100, IRVINE, CA, 92618, US

(73) Assignee: Superconductor Technologies, Inc.

(21) Appl. No.: 10/391,667

(22) Filed: Mar. 18, 2003

Related U.S. Application Data
(60) Provisional application No. 60/384,591, filed on May 29, 2002.

(51) Int. Cl. H01P 1/203; H01B 12/02

(52) U.S. Cl. 333/99 S; 333/204; 505/210

(57) ABSTRACT

A filter comprising a plurality of zig-zag hairpin-comb resonators that are separated by one or more coupling gaps is provided. The zig-zag hairpin-comb resonators may be fabricated using HTS or non-HTS planar structures, such as microstrip, stripline and suspended stripline. Each of the zig-zag hairpin-comb resonators comprises a pair of neighboring legs. The neighboring legs of adjacent resonators straddle a respective coupling gap. Each of the neighboring legs is formed with zig-zag sections. In this manner, the filters provide unusual compactness, as well as minimizing coupling between the resonators.

### RELATED APPLICATION

This Application claims priority to U.S. Provisional Application No. 60/384,591 filed on May 29, 2002. The above-identified Provisional Application is incorporated by reference as if set forth fully herein.

### GOVERNMENT LICENSE RIGHTS

The U.S. Government has a paid-up license in this invention and the right in limited circumstances to require the patent owner to license others on reasonable terms as provided for by the terms of Contract MDA972-00-C-0010 awarded by the Defense Advanced Research Projects Agency (DARPA).

### FIELD OF THE INVENTION

This invention generally relates to microwave filters, and more particularly, to microwave filters designed for narrow-band applications.

### BACKGROUND OF THE INVENTION

Filters have long been used in the processing of electrical signals. For example, in communications applications, such as microwave applications, it is often desirable to filter out the smallest possible passband and thereby enable dividing a fixed frequency spectrum into the largest possible number of bands.

Such filters are of particular importance in the telecommunications field (microwave band). As more users desire to use the microwave band, the use of narrow-band filters will increase the actual number of users able to fit in a fixed spectrum. Of most particular importance is the frequency range from approximately 800-2,200 MHz. In the United States, the 800-900 MHz range is used for analog cellular communications. Personal communication services are used in the 1,800 to 2,200 MHz range.

Historically, filters have been fabricated using normal, that is, non-superconducting conductors. These conductors have inherent lossiness, and as a result, the circuits formed from them having varying degrees of loss. For resonant circuits, the loss is particularly critical. The quality factor (Q) of a device is a measure of its power dissipation or lossiness. For example, a resonator with a higher Q has less loss. Resonant circuits fabricated from normal metals in a microstrip or stripline configuration typically have Q's at best on the order of four hundred. See, e.g., F. J. Winters, et al., “High Dielectric Constant Strip Line Band Pass Filters,” IEEE Transactions On Microwave Theory and Techniques, Vol. 39, No. 12, December 1991, pp. 2182-87.

With the discovery of high temperature superconductivity in 1986, attempts have been made to fabricate electrical devices from high temperature superconductor (HTS) materials. The microwave properties of HTS's have improved substantially since their discovery. Epitaxial superconductor thin films are now routinely formed and commercially available. See, e.g., R. Hammond et al, “Epitaxial Tl₂Ca₁Ba₂Cu₂O₈ Thin Films With Low 9.6 GHz Surface Resistance at High Power and Above 77° K.,” Applied Physics Letters, Vol. 57, pp. 825-27 (1990). Various filter structures and resonators have been formed from HTS materials. Other discrete circuits for filters in the microwave region have been described. See, e.g., S. H. Talisa, et al., “Low- and High-Temperature Superconducting Micro-wave filters,” IEEE Transactions on Microwave Theory and Techniques, Vol. 39, No. 9, September 1991, pp. 1448-1554, and “High Temperature Superconductor Staggered Resonator Array Bandpass Filter,” U.S. Pat. No. 5,616,538.

Currently, there are numerous applications where microstrip narrow-band filters that are as small as possible are desired. This is particularly true for wireless applications where HTS technology is being used in order to obtain filters of small size with very high resonator Q's. The filters required are often quite complex with perhaps twelve or more resonators along with some cross couplings. Yet the available size of usable substrates is generally limited. For example, the wafers available for HTS filters usually have a maximum size of only two or three inches. Hence, means for achieving filters as small as possible, while preserving high-quality performance are very desirable.

In the case of narrow-band microstrip filters (e.g., bandwidths of the order of 2 percent, but more especially 1 percent or less), this size problem can become quite severe. In narrow-band microstrip filters, substantial differences between even-mode and odd-mode wave velocities exist when the substrate dielectric constant is large. In filters utilizing parallel-coupled lines, this can create relatively large forward coupling between resonators, thereby presenting a need for large spacings between the resonators in order to obtain the required narrow band-width. See, G. L. Matthaei and G. L. Hey-Shipton, “Concerning the Use of High-Temperature Superconductivity in Planar Microwave Filters,” IEEE Transactions on Microwave Theory and Techniques, vol. 42, pp. 1287-1293, July 1994. This may make the overall filter structure unattractively large or, perhaps, impractical or impossible for some situations.

Limiting the size of filter structures is not the only problem that must be addressed when designing filters. For example, complex filter structures may be difficult to accurately model during the design process due to unwanted and unpredictable stray coupling between resonators. Also, the bandwidth and shape of the passband of tunable microstrip bandpass filters may vary greatly as the tuning capacitance is varied.

FIG. 1 shows a two-resonator comb-line filter structure 30 realized in a stripline configuration uniformly surrounded by air or other dielectric, so that the even-mode and odd-mode velocities on the coupled lines will be equal (thus, preventing forward coupling). The two resonators 32 are grounded to sidewall 34, and in this example, the input and output couplings 36 are provided by tapped-line connections. This structure would have no passband at all of it were not for the “loading” capacitors Cr 38. From the equivalent circuit for a comb-line filter, it can be seen why this happens. See, G. L. Matthaei, L. Young, and E. M. T. Jones, Microwave Filters, Impedance-Matching Networks, and Coupling Structures, Artech House Books, Dedham, Mass., 1980, pp. 497-506 and 516-518.

Since the resonators 32 are shorted at one end, when loading capacitors are zero (Cr=0), the resonators 32 are resonant when they are a quarter-wavelength long. As seen from their open-circuited ends, they look like coupled connected, parallel-type resonators, which would tend to yield a passband at this frequency. However, there is also an odd-mode resonance in the coupling region between the lines, which acts like a bandstop resonator connected in series between two shunt resonators. This creates a pole of attenuation at the same frequency that a passband would otherwise occur. Thus, the potential passband is totally blocked. However, if loading capacitors, Cr>0, are added at the ends of the resonators 32, the resonator lines must be shortened in order to maintain the same resonant frequency. This shortens the length of the slot between the lines and causes the pole of attenuation to move up in frequency away from the resonance of the resonators and the passband will appear.

In general, the more capacitive loading used, the further the pole of attenuation would be above the passband, and the wider the passband of the filter structure 30 can be If only small loading capacitors Cr are used, a very narrow passband can be achieved even though the resonators 32 are physically quite close together. Similar operation also occurs if more resonators 32 are present. If the filter structure 30 is realized in a microstrip configuration on a dielectric substrate, the performance is considerably altered because of the different even-mode and odd-mode velocities, though some of the same properties exist in modified form.

FIG. 2 shows a common form of hairpin-resonator bandpass filter structure 40. See, E. G. Cristal and S. Frankel, “Hairpin-Line and Hybrid Hairpin-Line/Half-Wave Parallel-Coupled-Line Filters,” IEEE Transactions on Microwave Theory and Techniques, vol. 20, pp. 719-728, November 1972. The filter structure 40 can be thought of as an alternative version of the parallel-coupled-resonator filter introduced by S. B. Cohn in “Parallel-Coupled Transmission-Line-Resonator Filters,” IRE Trans. PGMTT, vol. MTT-6, pp. 223-231 (April 1958), except that here the parallel-coupled resonators are folded back on themselves. As seen in FIG. 2, the orientations of the hairpin-resonators 42 alternate (i.e., neighboring resonators face opposite directions). This causes the electric and magnetic couplings to add and results in quite strong coupling. Consequently, this structure is capable of considerable bandwidth. However, in the case of narrow-band filters, particularly for microstrip filters on a high-dielectric substrate, this structure is undesirable as it may require quite large spacings between resonators 42 to achieve a desired narrow bandwidth.

FIG. 3 shows a “hairpin-comb” filter structure 80, which has properties that are quite useful for narrow-band filters. The hairpin-comb filter structure 80 comprises a plurality of hairpin (i.e., folded in the shape of a hairpin) half-wavelength microstrip or stripline resonators 82 arranged side-by-side and oriented in the same direction. The coupling regions 84 between resonators 82 extend parallel to the sides 86 of the resonators 82 for substantially ⅛ to ¼ the wavelength at the resonance frequency. Having all of the resonators oriented in the same direction as in FIG. 3 results in the electric and magnetic couplings tending to cancel each other, thus significantly reducing the net coupling.

Still referring to FIG. 3, a subtle but important phenomenon occurs in the hairpin-comb filter structure 80. In the hairpin-comb filter structure 80 a resonance effect occurs in the vicinity of the coupling regions 84, thereby creating a pole of attenuation (i.e., frequency of infinite attenuation) adjacent to the passband. This pole is useful for enhancing stopband attenuation. If the hairpin-comb filter structure 80 is in a homogenous dielectric, the pole of attenuation will occur above the passband. In the case of conventional microstrip, however, the even-mode and odd-mode wave velocities for pairs of coupled lines are different. Consequently, the pole of attenuation typically occurs below the passband. The position of this pole of attenuation, however, can be controlled to some extent by the addition of capacitive coupling 88 between the open ends of adjacent resonators 82, as illustrated, for example, in FIG. 4. When small amounts of capacitance are added, the pole of attenuation moves upwards in frequency towards the passband and causes the passband to be further narrowed. At some point the pole of attenuation will move into the passband, killing it completely. Adding still more capacitance will cause the pole to move up above the passband. This control of the position of the pole of attenuation generated in the coupling regions is a potentially useful feature for hairpin-comb filters.

FIG. 5 shows another common form of hairpin-resonator filter structure 50. See, M. Sagawa, K. Takahashi, and M. Makimoto, “Miniaturized Hairpin Resonator Filters and Their Application to Receiver Front-End MIC's,” IEEE Transactions on Microwave Theory and Techniques, vol. 37, pp. 1991-1997 (December 1989). In this case, the open-circuited ends of the resonators 52 are considerably foreshortened and a strongly capacitive gap 54 is added to bring the remaining structure into resonance. The resonators are then semi-lumped, the lower part 56 being inductive and the upper part 58 being capacitive. The remaining coupling between resonators 52 is almost entirely inductive, and it makes little difference whether adjacent resonators are inverted with respect to each other or not because the magnitude of the inductive coupling is unaffected. Hence, as is shown in FIG. 5, these resonators 52 are usually made to have the same orientation. If the resonators have sufficiently large capacitive loading, these resonator structures can be quite small, but, typically, their Q is inferior to that of a full hairpin resonator. Also, there will normally be no resonance effect in the region between the resonators 52 so that the coupling mechanism cannot be used to generate poles of attenuation beside the passband in order to enhance the stopband attenuation.

FIG. 6 shows a structure that has some similarities to a hairpin-comb filter, but is very different in some fundamentally important aspects. See J-S Hong and M. J. Lancaster, “Design of highly selective microstrip bandpass filters with a single pair of attenuation poles at finite frequencies,” IEEE Trans. Microwave Theory and Tech., vol. 48, pp. 1098-1107, no. 7, July 2000. Similar to the hairpin-comb structure, this structure uses nominally half-wavelength folded resonators. However, in the structure shown in FIG. 6, the resonators are folded into rectangles, and the lines on the sides (i.e., those lines coupling to adjacent resonators in FIG. 6) are not long enough to create significant resonance effects in the coupling region between the resonators 62 (as occurs in hairpin-comb structures). Also, the relative orientations of the resonators in the structure shown in FIG. 6 are entirely different from that in a hairpin-comb filter. For example, resonators 1 and 2 in FIG. 6 have opposing orientations (i.e., the gaps are on opposite sides) as in the conventional comb-line filter in FIG. 2. Resonators 2 and 3 are coupled by placing their high-current ends (i.e., the ends without gaps) together which gives magnetic coupling. Resonators 3 and 6 are coupled at their maximum voltage ends (i.e., the ends with gaps) giving capacitive coupling. Moreover, the structure shown in FIG. 6 cannot easily obtain the weak couplings required for very narrow-band filters.

FIG. 7 shows another version of this circuit. See J-S Hong, M. J. Lancaster, et al, “On the performance of HTS microstrip quasi-elliptic function filters for mobile communications applications,” IEEE Trans. Microwave Theory and Tech., vol. 48, pp. 1240-1246, no. 7, July 2000. This is the same circuit as in FIG. 6 but the transmission lines have been zig-zagged somewhat. As was true for the circuit in FIG. 6, however, this filter is fundamentally different than a hairpin-comb filter as well as the below described zig-zag hairpin-comb filters. For instance, several of the resonators in the structure of FIG. 7 have opposing orientations (e.g., resonators 1 and 2; resonators 7 and 8). In addition, resonators 2 and 3 are coupled by placing their high-current ends (i.e., the ends without gaps) together which gives magnetic coupling. In contrast, resonators 3 and 6 are coupled at their maximum voltage ends (i.e., the ends with gaps) giving capacitive coupling. Finally, the structure shown in FIG. 7 cannot easily achieve the weak couplings required for very narrow-band filters.

The use of hairpin-comb filters is seen to be helpful in obtaining relatively small narrow-band filters with resonators that lend themselves to quite high unloaded Q's. For applications where large numbers of resonators must be used on substrates of very limited size, or for filters on such substrates with a modest number of resonators, but with their passband at relatively low frequencies (say, in the one hundred MHz range), even more compact structures are needed.

For very narrow-band bandpass filters the couplings between the resonators must be very weak. Where such filters are realized in microstrip form, unwanted stray couplings may be quite significant in size compared to the desired couplings. This can greatly complicate the accurate design of such structures since the unwanted couplings must also be included as well as the wanted ones.

Problems resulting from stray coupling are not unique to narrowband bandpass filters. Many microwave bandstop filters are realized using a number of resonators coupled to a transmission line, where the resonators are spaced a quarter-wavelength apart along the transmission line. See, e.g., G. L. Matthaei, L. Young, and E. M. T. Jones, “Microwave Filters, Impedance-Matching Networks, and Coupling Structures,” Norwood, Mass.: Artech House (1980), Chapter 12. There is, however, a major difficulty in designing narrow-band microstrip bandstop filters with resonators spaced along a transmission line. The problem arises because the filter passband region adjacent to the stopband is extremely sensitive to any stray coupling between the resonators. Typical microstrip resonators will have sufficient stray coupling between resonators to create intolerable distortion of the passbands in bandstop filters with narrow stop bands. To avoid this problem, the coupling coefficient for the stray coupling between adjacent resonators must be very small compared to the fractional stopband width of the filter. In order to obtain sufficient isolation between resonators, it is common in such cases to place each resonator in a separate housing. The use of zig-zag hairpin resonators as discussed below provides a means for reducing the stray coupling between resonators and, at least in some cases, eliminating the need for placing the resonators in separate housings.

Separate from the problem of reducing the size of resonators and reducing stray coupling, many electronically tunable filters employ electronically variable capacitors. FIG. 8 functionally shows a tunable filter structure 90 that is typically the most practical way to realize a filter with such tuning capacitors C_{VAR}. Note that the filter structure 90 uses fixed inductors L and fixed coupling capacitors C. In most practical applications, it is desired to maintain a constant bandwidth Δf as the filter structure 90 is tuned. Unfortunately, for the tunable filter structure 90, due to the frequency variation of the coupling reactances and the variation of the resonator characteristics as the resonators are tuned, the bandwidth of the tunable filter structure 90 will increase with center frequency f₀ as f₀³ instead of being constant with frequency. Further, in order to preserve the shape of the filter passband, the external Q's of the end resonators should increase linearly with f₀. For the tunable filter structure 90, however, the external Q's will, instead, decrease with f₀ as 1/f₀³. Thus, the tunable filter structure 90 will have very strong variations in the passband width and shape as the filter structure 90 is tuned.

If one could realize a practical filter consisting of capacitively tuned, series L-C resonators along with inductance couplings, the bandwidth variation would not be as severe. It can be shown that the bandwidth would vary linearly with f₀, while the external Q's of the end resonators would vary as 1/f₀ (instead of the linear variation desired for the external Q's). Thus, the bandwidth and passband shape errors incurred in this type of filter would not be as bad as are those for the tunable filter structure 90. For the case of filters having a combination of capacitive and inductive coupling, the errors in the response as the filter is tuned would probably lie somewhere between the two extremes discussed above. However, it is clear that in any case, special measures will be required in order to design filters to maintain constant bandwidth and passband shape as the filter is tuned. This problem has been variously addressed, but none of the solutions demonstrate relative compact tunable filter structures that can maintain a nearly constant bandwidth over a relatively wide frequency range.

### SUMMARY OF THE INVENTION

The present inventions are directed to novel frequency filtering structures. The filter structures contemplated by the present invention may be planar structures, such as microstrip, stripline and suspended stripline. In preferred embodiments, the conductors in the resonator may be composed of HTS material. The broadest aspects of the invention, however, should not be limited to HTS material, and contemplate the use of non-HTS material as well.

Some aspects of the present invention contemplate the design of narrow-band bandpass filter structures and zig-zagged hairpin-comb resonators used to design such filter structures. These filter structures comprises a plurality of side-coupled zig-zagged hairpin-comb resonators and one or more coupling gaps respectively between the plurality of resonators. For example, the filter can include as few as two resonators with a single coupling gap, or four or more resonators with three or more coupling gaps. The resonators may be formed of planar structures, such as microstrip, stripline and suspended stripline. The filter may include input and output couplings connected to the first and last resonators of the filter for providing signal to and from the filter. In the preferred embodiment, each of the resonators has a nominal linear line length of a half-wavelength at the resonant frequency.

Each of the “zig-zag hairpin-comb” resonators comprises a pair of legs. The legs of a single resonator straddle a respective centerline gap with a connecting line between the legs at one end of terminal end thereof. Coupling gaps are formed within the region between adjacent legs of adjacent resonators. In a preferred embodiment, all of the resonators will have a connecting line located at the same end of the resonators' respective centerline gap. In this regard, all of the resonators will be oriented in the same direction. At least a portion of each of the legs of a resonator is formed with zig-zag sections. Each zig-zag section includes two “coupling segments” consisting of line sections parallel to the legs in the resonators. Multiple zig-zag sections form arrays of coupling segments. The array of coupling segments that lie closest to the gap between resonators provide most of the coupling between adjacent resonators. Meanwhile the array of coupling segments adjacent to the centerline of a resonator provide relatively little coupling to an adjacent resonator because these coupling segments are relatively far from the coupling gap. In addition, the zig-zag sections include an array of “non-coupling segments” consisting of line sections that are oriented perpendicular to the legs in the resonator. These sections provide extremely little magnetic coupling between resonators and greatly reduced electric coupling. In this manner, a zig-zag section can be thought of as consisting of an array of non-coupling segments interconnected by arrays of coupling segments. Filters formed using the zig-zag hairpin-comb resonators provide unusual compactness because of the zig-zags along with the hairpin configuration.

To provide maximum effect, the entirety of each of the neighboring legs (i.e., adjacent legs from separate resonators) can have zig-zag sections. In the preferred embodiment, both legs of every resonator include zig-zag sections to maintain the symmetry of the resonators. The resonators can be arranged in a single row, or depending on the number of resonators, can be arranged in a plurality of rows with bridging resonators coupling the resonator rows to further reduce the required space needed for the filter. A pole of attenuation is associated with the coupling gap between resonators. Capacitance can be connected between resonators to provide control of the frequency of this pole of attenuation. Alternatively, the frequency position of this pole of attenuation can be adjusted by appropriate alteration of the lengths of the coupling segments in adjacent resonators. Still another way to control the position of the pole of attenuation is to vary the spacings between the coupling segments adjacent to the gap between adjacent resonators such that the distance between resonators varies from one end of the coupling gap to the other.

In the preferred embodiment, the non-coupling segments (i.e., those perpendicular to the coupling gaps) are made appreciably longer than the coupling segments (i.e., those parallel to the coupling gap). In this manner there is relatively weak coupling between resonators so that a narrow-band filter can be realized even with quite close spacings between resonators (thus permitting the overall filter structure to be even more compact). This configuration also has unusually weak stray couplings between non-adjacent resonators so, at least in most cases, it is practical to ignore such unwanted, stray couplings in the design process. This can greatly simplify the obtaining of accurate filter designs.

In accordance with a preferred aspect of the invention, the pair of legs on each resonator form an open end and a closed end, wherein the plurality of resonators is oriented with the open ends thereof in a common direction. This relative orientation between adjacent resonators causes the electric and magnetic coupling components of the couplings to tend to cancel. In this manner, coupling between the resonators is further reduced, thus permitting still smaller coupling gaps between the resonators.

In accordance with another aspect of the invention, the lengths of the individual coupling and non-coupling segments of the zig-zag section may be nonuniform. Varying the length of the individual coupling and non-coupling segments of the zig-zag section allows one to vary the coupling between the resonators and to move the pole of attenuation associated with the respective coupling gap upward or downward in frequency. For example, the lengths of the non-coupling segments of the zig-zag sections adjacent the open end of the resonator can be decreased or increased relative to the lengths of the non-coupling segments of the zig-zag sections adjacent to the closed end, thereby respectively decreasing or increasing the electric coupling between the resonators relative to the amount of magnetic coupling so as to move the pole of attenuation downward or upward in frequency.

In accordance with a separate aspect of the present invention, the position of the pole of attenuation associated with a given coupling gap can be controlled by changes in the zig-zag portions of the resonator legs. In this aspect, there is a constant spacing between adjacent resonators along each coupling gap. The ratio of electric coupling to magnetic coupling may be adjusted (and the position of the related pole of attenuation) by altering the length of the coupling segments of the zig-zag sections along the length of the coupling gap. (See FIGS. 18 and 19).

In accordance with another aspect of the present inventions, the narrow-band bandpass filter structure can be made tunable by locating tuning capacitors between the open-circuited ends of the legs of each zig-zag hairpin-comb resonator. In order to permit constant bandwidth as the filter is tuned, the coupling coefficients for the couplings between the zig-zag hairpin-comb resonators must vary inversely with the passband frequency. This can be accomplished to a good approximation in zig-zag hairpin-comb filter structures by designing the resonators so as to locate the poles of attenuation associated with the coupling gaps between resonators at optimal frequencies above the filter tuning range of interest. Meanwhile, in order to maintain the desired filter passband shape it is necessary that the external Q of the end resonators increase linearly with the tuning frequency. The present invention achieves this result to a good approximation by inclusion of reactance circuits at the input and output of the filter that cause the external Q's of the end resonators to vary in the desired manner.

In a preferred embodiment of a filter tunable with nearly constant bandwidth, the pairs of legs for each zig-zag hairpin-comb resonator form open and closed ends, and either the lengths of the non-coupling segments of the zig-zag sections adjacent the open end are decreased relative to lengths of the non-coupling segments of the zig-zag sections adjacent the closed end, or, possibly in some situations, the spacings between zig-zag sections adjacent the open end may be increased relative to spacings between zig-zag sections adjacent the closed end, to accomplish the desired effect. The filter structure may further comprise resonating circuits in series with input and output couplings. Both such resonant circuits may comprise a paralleled arrangement of an inductor, possibly approximated by a relatively high-impedence meander line, and a capacitor, such as an interdigital capacitor. The resonant circuits may advantageously force the external Q's of the resonators to increase approximately linearly with frequency and provide the passband with an acceptable shape.

The narrow-band filter structures contemplated by the present invention can also take the form of narrow-band bandstop filter structures. In accordance with a separate aspect of the present invention, a narrow-band bandstop filter structure may comprise a transmission line, and a plurality of zig-zag hairpin-comb resonators spaced adjacent to the transmission line at regular intervals. Each of the hairpin resonators comprises a pair of legs, with at least a portion of each of the legs forming zig-zag sections. In the preferred embodiment, the hairpin resonators are spaced along the transmission line at intervals of one-quarter wavelength at the resonant frequency. The transmission line can include transmission line sections between the resonators that are zig-zagged. Alternatively, the transmission line may be replaced by a lumped-element (or semi-lumped-element) approximation of a transmission line consisting of a cascade of series inductive elements alternating with shunt-capacitive capacitive elements. The pair of legs of each resonator in the filter may form an open end and a closed end, such that the closed ends of the resonators are adjacent to the transmission line.

Although the present inventions, in their broadest aspects, should not be so limited, use of zig-zag hairpin resonators in narrow-band bandstop filter structures has an advantage in that there is relatively little stray coupling between the resonators. As a result, in many cases, the stray coupling between zig-zag hairpin-comb resonators will be sufficiently small that a satisfactory transmission response can be obtained without the complication and expense of using housings around the individual resonators, as may be required if more conventional microstrip resonators are used.

The present invention also contemplates tunable filter structures that are not necessarily limited to zig-zag hairpin resonators. In accordance with another aspect of the present invention, a tunable filter structure comprises one or more tunable resonators, e.g., a single hairpin resonator with input and output couplings connected to its respective legs, or a plurality of tunable resonators, in which case, the input coupling is connected to the first resonator, and the output coupling is connected to the last resonator. If the resonators are hairpin resonators, they can be tuned, e.g., by placing variable capacitors between the open ends of each of the resonators. The tunable filter further includes reactance circuits (having a pole of reactance at a frequency somewhat above the tuning range of the filter) coupled in series with one or both input and output terminations.

In this manner, the series-connected, parallel-type reactance resonating circuits at the terminations, in the preferred embodiment, force the external Q's of the end resonators to vary in such a way as to maintain the desired passband shape (e.g., the passband ripple) as the filter is tuned. By way of non-limiting example, each resonator in the filter may comprise a paralleled arrangement of an inductor, such as a meander line, and a capacitor, such as an interdigital capacitor with capacitor couplings between the resonators. This particular example would not have constant bandwidth but could maintain the desired passband shape. Although the present invention should not necessarily be limited thereby, the resonator(s) used in the filter structure can include hairpin resonators, whether zig-zagged or not. In the above example having series-connected reactance circuits at its ends, the resonators used exhibit a parallel-type of resonance. It is obvious to those skilled in the art, however, that if the filter used resonators that exhibit a series-type of resonance, duality would apply and one would want to use shunt-connected, series-type reactance circuits at the ends of the filters in order to correct the shape of the passband.

It is an object of the invention to provide for very small, compact resonators. It is a further object of the invention to provide a structure having weak couplings between resonators, such as those required for narrow-band filters, while still maintaining relatively small spacings between resonators. It is yet another object of the invention to provide a filter having very low parasitic coupling beyond the nearest neighbor resonators so that unwanted parasitic coupling can be ignored in the design process. It is a further object of the invention to provide narrow-band bandstop filters that do not require a separate housing for each resonator. An additional object of the invention is to provide for tunable filters which maintain a nearly constant bandwidth and passband shape as the filter is tuned. The same principles can be adapted to achieve some desired variation of bandwidth vs. frequency that might be desired in special situations.

### BRIEF DESCRIPTION OF THE DRAWINGS

FIG. 1 illustrates a prior art two-resonator stripline comb-line filter structure.

FIG. 2 illustrates a prior art four-resonator microstrip hairpin resonator filter structure.

FIG. 3 illustrates a prior art four-resonator hairpin-comb resonator filter structure.

FIG. 4 illustrates a prior art three-resonator hairpin-comb resonator filter structure with added coupling capacitances.

FIG. 5 illustrates a prior art microstrip four-resonator, capacitively loaded, hairpin resonator filter structure.

FIG. 6 illustrates a prior art microstrip eight-resonator filter structure.

FIG. 7 illustrates another prior art microstrip eight-resonator filter structure.

FIG. 8 illustrates a schematic of a prior art tunable bandpass filter that is tuned by variable capacitors.

FIG. 9 (a) illustrates a microstrip two-resonator, zig-zag hairpin-comb narrow-band bandpass filter structure constructed in accordance with one preferred embodiment of the present invention.

FIG. 9(b) is partial close-up view of the zig-zag hairpin-comb narrow-band bandpass filter of FIG. 9(a).

FIG. 10 illustrates the measured and computed frequency responses of an exemplary filter similar to the filter of FIGS. 9(a) and 9(b).

FIG. 11 illustrates a four-resonator, zig-zag hairpin-comb narrowband bandpass filter structure constructed in accordance with another preferred embodiment of the present invention.

FIG. 12 illustrates the measured and computed frequency responses of an exemplary filter similar to the filter of FIG. 11.

FIG. 13 illustrates a seven-resonator zig-zag hairpin-comb narrowband bandpass filter structure constructed in accordance with still another preferred embodiment of the present invention. The filter contains couplings beyond the nearest neighbor added to the first and seventh resonators.

FIG. 14 illustrates a portion of a folded zig-zag hairpin-comb narrowband bandpass filter structure constructed in accordance with still another preferred embodiment of the present invention.

FIG. 15 illustrates a three-resonator narrow-band bandstop filter structure utilizing zig-zag hairpin resonators constructed in accordance with still another preferred embodiment of the present invention.

FIG. 16 illustrates a microstrip two-resonator zig-zag hairpin-comb narrow-band bandpass filter constructed in accordance with yet another preferred embodiment of the present invention, wherein the lengths of the zig-zag sections are adjusted to move a pole of attenuation downward in frequency.

FIG. 17 illustrates a microstrip two-resonator, zig-zag hairpin-comb narrow-band bandpass filter constructed in accordance with yet another preferred embodiment of the present invention, wherein the lengths of the zig-zag sections are adjusted to move a pole of attenuation upward in frequency.

FIG. 18 illustrates a two-resonator zig-zag hairpin-comb narrowband bandpass filter constructed in accordance with yet another preferred embodiment of the present invention, wherein the spacings between the zig-zag sections are adjusted to move a pole of attenuation downward in frequency.

FIG. 19 illustrates a two-resonator zig-zag hairpin-comb narrowband bandpass filter constructed in accordance with yet another preferred embodiment of the present invention, wherein the spacings between the zig-zag sections are adjusted to move a pole of attenuation upward in frequency.

FIG. 20 illustrates a tunable two-resonator zig-zag hairpin-comb narrow-band bandpass filter structure constructed in accordance with still another preferred embodiment of the present invention.

FIG. 21 illustrates a sketch of the reactance characteristics of the parallel-resonant circuits which are connected in series with the input and outputs of the filter structure of FIG. 20.

FIG. 22 illustrates the computed frequency response of an exemplary tunable filter similar to the tunable filter of FIG. 20.

FIG. 23 illustrates the superimposed measured frequency responses of the exemplary tunable filter of FIG. 22 for various center frequencies tuned from 0.498 to 0.948 GHz.

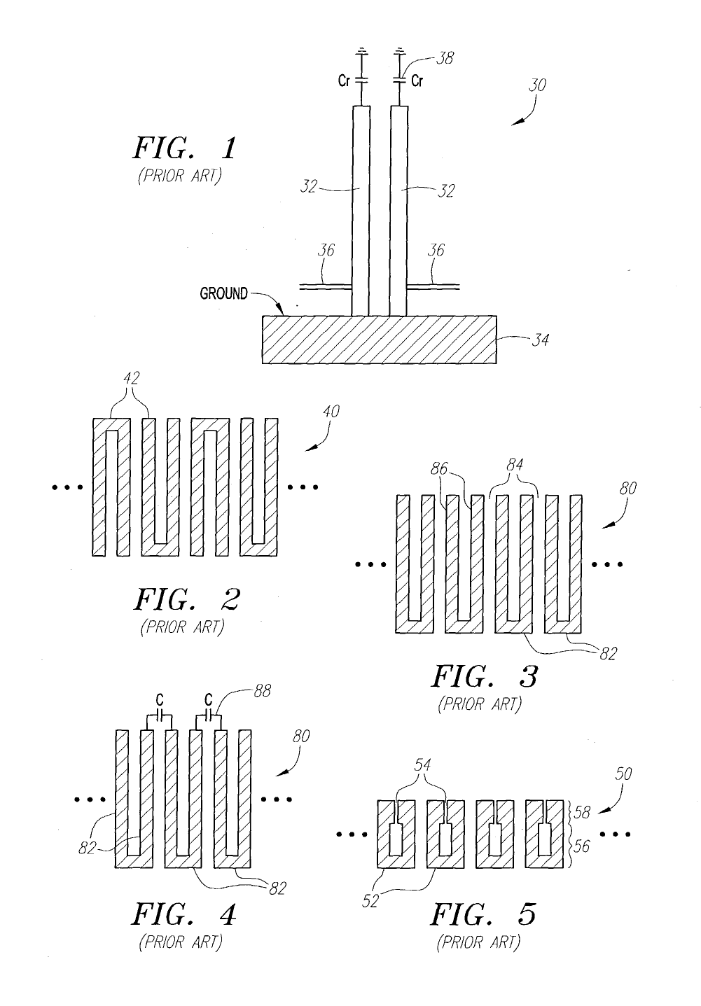

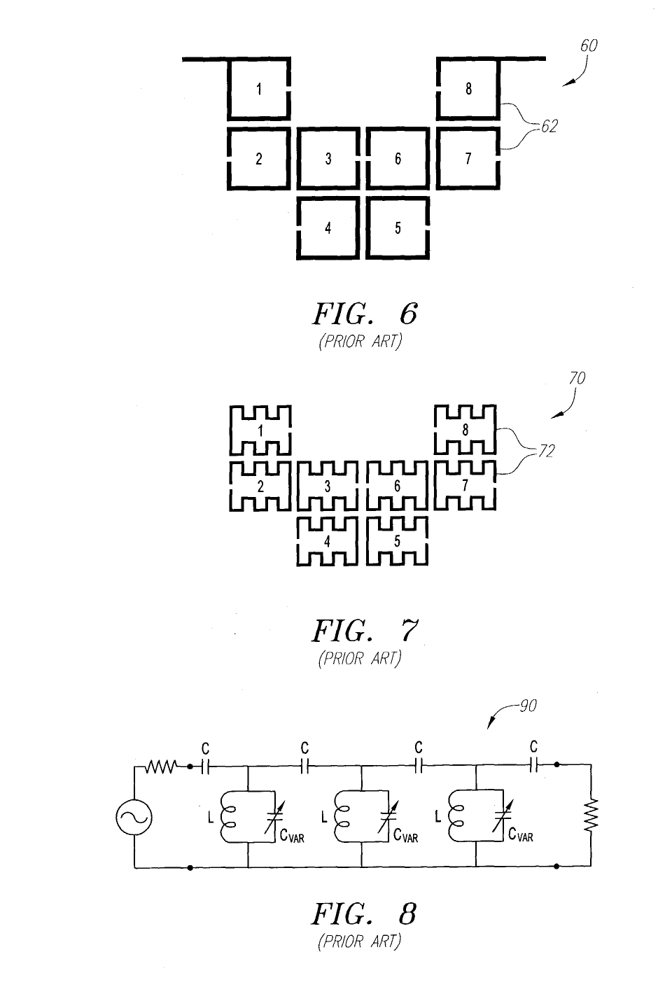

### DESCRIPTION OF THE PREFERRED EMBODIMENTS

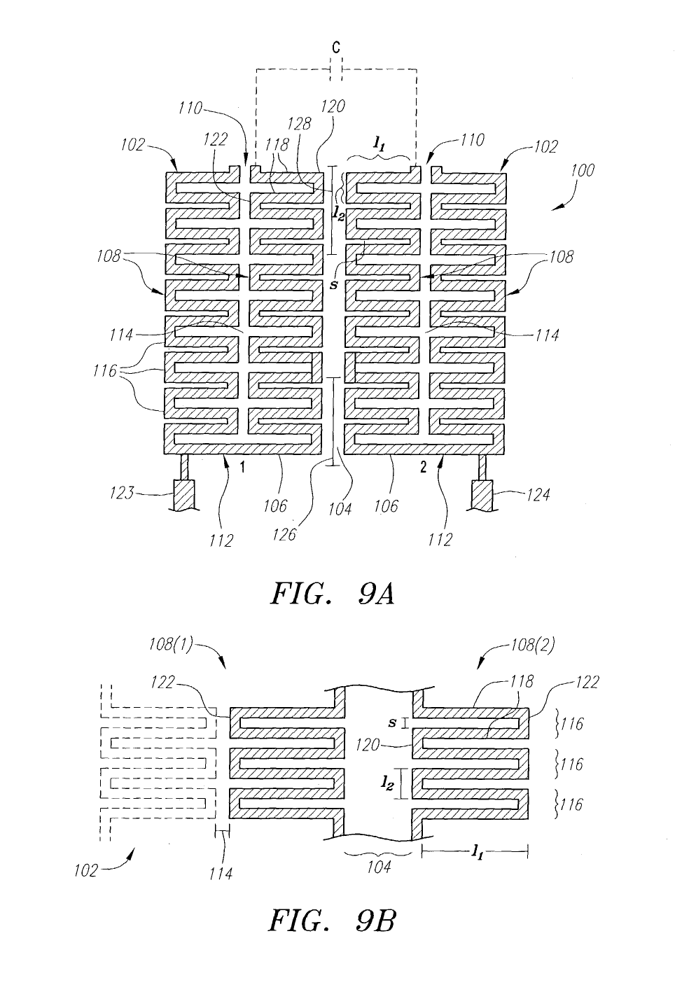

Referring to FIG. 9(a), a zig-zag hairpin-comb narrow-band bandpass filter structure 100 constructed in accordance with one preferred embodiment of the present invention will now be described. The filter structure 100 generally comprises two zig-zag hairpin-comb resonators 102 (numbered 1 and 2) that are arranged side-by-side, so that a coupling gap 104 is formed therebetween. In the illustrated embodiment, the zig-zag hairpin-comb resonators 102 are formed using microstrip. In the preferred embodiment, the zig-zag hairpin-comb resonators 102 are composed of a suitable HTS material and the substrate on which the resonators 102 are disposed is composed of a suitable dielectric material. It should be understood, however, that the zig-zag hairpin-comb resonator 102 may be formed from a non-HTS material. Although the zig-zag hairpin-comb resonators 102 are illustrated as being proportionate, if desired, they can be proportioned differently.

Each of the zig-zag hairpin-comb resonators 102 comprises a nominally one-half wavelength resonator line 106 at the resonant frequency. The resonator line 106 is folded into a “U” shape or “hairpin” configuration, such that each resonator 102 comprises a pair of neighboring legs 108, a high voltage open end 110, a high current closed end 112, and a center gap 114 that extends between the pair of legs 108. Both zig-zag hairpin-comb resonators 102 have their open ends 110 oriented in the same direction. This “hairpin-comb” configuration causes magnetic and electric couplings to tend to cancel. This further reduces coupling between resonators for a given coupling gap 104, thus permitting still smaller coupling gaps 104.

With reference to FIGS. 9(a) and 9(b), the neighboring legs 108 of each zig-zag hairpin-comb resonator 102 are constructed with a zig-zag configuration. In this regard, the lines 106 of the neighboring legs 108 of the zig-zag hairpin-comb resonator 102 are zig-zagged (or meandered) in order to reduce the size of the zig-zag hairpin-comb resonator 102 while at the same time presenting very limited coupling between adjacent and non-adjacent zig-zag hairpin-comb resonators 102. The zig-zag configuration is characterized by each neighboring leg 108 of the zig-zag hairpin-comb resonator 102 comprising a plurality of zig-zag sections 116. Each zig-zag section 116 includes a pair of parallel non-coupling segments 118 (as illustrated in FIGS. 9(a) and 9(b) as being arranged in the horizontal direction) having a length l₁ and an interconnecting outer coupling segments 120 (as illustrated in FIGS. 9(a) and 9(b) as being arranged in the vertical direction) having a length l₂. As illustrated, the pair of non-coupling segments 118 extend perpendicularly to the coupling gap 104, while the interconnecting outer coupling segments 120 extend parallel and adjacent to the coupling gap 104. The zig-zag sections 116 are spaced from each other by interconnecting inner coupling segments 122 that extend parallel and adjacent to the center gap 114 of the respective zig-zag hairpin-comb resonator 102 (oriented vertically in FIGS. 9(a) and 9(b)). The interconnecting inner coupling segments 122 define a spacing s between adjacent zig-zag sections 116 and contribute relatively little to the coupling between adjacent resonators because of their relatively far distance from the coupling gap 104.

In the embodiment shown in FIGS. 9(a) and 9(b), the outer coupling segments 120 of the neighboring legs 108 of the zig-zag hairpin-comb resonators 102 that straddle the coupling gap 104 provide most of the coupling between the zig-zag hairpin-comb resonators 102. The configuration of the zig-zag hairpin-comb resonators 102 is advantageous for narrow-band filters wherein it is necessary to achieve small amounts of coupling between resonators. As will be described in further detail below, the dimensions of the outer coupling segments 120, the interconnecting inner coupling segments 122 and the non-coupled segments 118 need not be uniform and may be advantageously varied in certain situations.

The zig-zag sections 116 present in the zig-zag hairpin-comb resonators 102 help to reduce coupling between the zig-zag hairpin-comb resonators 102, since most of the magnetic and electrical coupling results from the relatively short coupling segments 120 adjacent to the coupling gap 104. The degree of coupling between the zig-zag hairpin-comb resonators 102 is strongly influenced by the length (l₂) selected for these coupling segments 120, as well as the size of the coupling gap 104 between the zig-zag hairpin-comb resonators 102. Thus, it can be appreciated that the filter structure 100 achieves an unusual compactness, in part, because of the zig-zagging of the resonator lines 106; but also because the zig-zagging is done in such a way that the coupling between zig-zag hairpin-comb resonators 102 is markedly reduced, so that the zig-zag hairpin-comb resonators 102 can be placed closer together.

Referring to FIG. 9(a), The filter structure 100 further comprises an input 123 and output 124, which are illustrated as inductive-tap couplings formed at the closed ends 112 of the zig-zag hairpin-comb resonators 102. It should be noted, however, that other types of couplings can also be used for the input 123 and output 124. For example, series-capacitance couplings can alternatively be formed at the open end 110 of the zig-zag hairpin-comb resonators 102. Magnetic coupling to an adjacent low-impedance circuit could also be a possibility.

There is a pole of attenuation in the frequency response of zig-zag harpin-comb filters 100 associated with a resonance effect in each coupling gap 104 between zig-zag hairpin-comb resonators 102. The frequency location of the pole produced in a given coupling gap 104 can be adjusted to some extent by the introduction into the zig-zag hairpin-comb filter structure 100 of an optional capacitance C (shown by dashed lines in FIG. 9(a)) between the adjacent top corners of the zig-zag harpin-comb resonators 102.

Poles of attenuation created by the coupling gaps 104 can be used to aid in achieving desired attenuation characteristics, and by placing the poles relatively close to the desired passband they can be utilized to further reduce the coupling between zig-zag harpin-comb resonators 102 so as to narrow the passband. Alternatively, by inclusion of coupling capacitances so as to move these poles of attenuation to be near the passband and thus reduce the coupling between the zig-zag harpin-comb resonators 102, a given passband width can be obtained with a smaller spacing between zig-zag harpin-comb resonators 102 therefore giving an even more compact design.

As will be described in detail below, the effective introduction of either positive or negative coupling capacitance can be achieved in a very practical way by strategically adjusting the shape of the coupling gaps 104 between zig-zag harpin-comb resonators 102. With respect to the terms “positive capacitance” and “negative capacitance,” to add negative coupling capacitance merely means to reduce the coupling capacitance that is already present. In contrast, positive coupling means the addition of more coupling capacitance. As discussed in more detail below, the measures taken to adjust the amount of inductive coupling between zig-zag harpin-comb resonators 102 can also be used to vary the frequency position of a pole of attenuation associated with a coupling gap 104. Magnetic coupling occurs predominantly in the vicinity of the adjacent lower coupling segments 126 of the zig-zag harpin-comb resonators 102 as seen in FIG. 9(a). Electric coupling, on the other hand, occurs predominantly in the vicinity of the adjacent upper coupling segments 128 of the zig-zag harpin-comb resonators 102 as seen in FIG. 9(a).

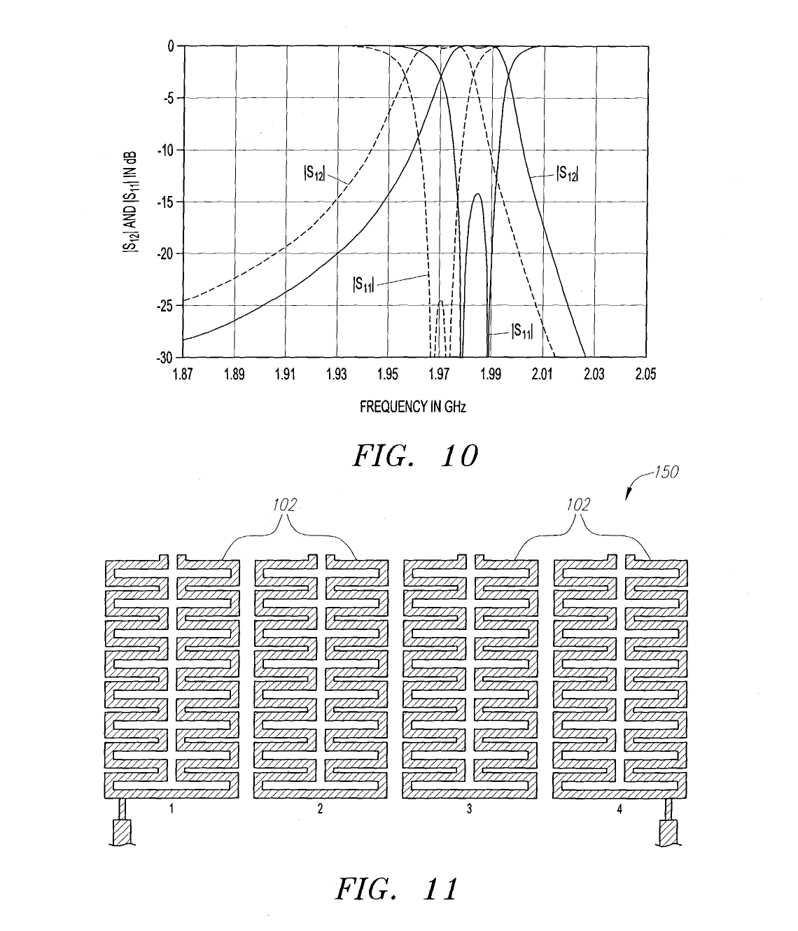

By way of non-limiting example, a two-resonator filter as illustrated in FIG. 9(a) was designed to have a center frequency of 2 GHz. The resonators utilized an epitaxial Tl₂Ca₁Ba₂Cu₂O₈ thin film, and the substrate was composed of 0.508 mm thick magnesium oxide material (eᵣ=9.7). The resonators were 3.49 mm wide and 4.8 mm long, and were spaced apart by 0.45 mm. FIG. 10 shows the measured passband response of this exemplary filter, with the dashed lines representing the response computed using SONNET software, and the solid lines representing the response measured at 77° K. The measured bandwidth at the 3-dB level is 26 MHz, which compares well with the computed 3-dB bandwidth of 26.7 MHz.

The measured passband ripple is somewhat larger than the computed ripple. It is believed that this was at least largely due to the fact that the metal mounting structures on the available dielectric tuners were too large to permit placing the centers of the tuners as close together as were the centerlines of the resonators. Thus, the tuners affected the two sides of the resonators unequally. It can be shown that such asymmetry in loading the two sides of a tapped hairpin resonator throws off the effective electric position of the tap so as to increase the external Q of the resonators, resulting in larger passband ripples.

The measured passband center is around 13.9 MHz higher than was computed. In the SONNET calculations, a 0.025 mm square cell size was used. Additional computer studies indicated that this error in computed center frequency was largely due to this finite cell size used in computing the response of the circuit.

Preliminary measurements of the exemplary resonator unloaded Q's suggests Q's in excess of 39,000. The attenuation on the high side is seen to be unusually sharp due to a pole of attenuation at 2.058 GHz, while the attenuation is somewhat weak on the low side of the passband. Interestingly enough, tap connections can be used to enhance the attenuation by creating additional poles of attenuation on both sides of the passband. These result from quarter-wave resonances in the two sides of the resonator, which short out the tap at frequencies somewhat above and below the resonator center frequency. Though this effect has worked well in other examples, it was lost in this example, possibly due to stray coupling between the input and output lines.

Referring now to FIG. 11, a zig-zag hairpin-comb narrow-band filter structure 150 constructed in accordance with another preferred embodiment of the present invention will now be described. The filter structure 150 is similar to the above-described filter structure 100, with the exception that it generally comprises four zig-zag hairpin-comb resonators 102 (numbered 1-4), with resonators 1 and 4 characterized as end resonators and resonators 2 and 3 characterized as inner resonators.

By way of non-limiting example, an actual filter, as illustrated in FIG. 11, was designed. The size and composition of the resonators 1-4 were identical to the size and composition of the resonators 1-2 used in the exemplary two-resonator filter structure 100. To expedite the design of the initial four-resonator filter, the same couplings to the terminations and the same 0.450 mm spacings between resonators 1 and 2 and between resonators 3 and 4 were used as was used in the exemplary two-resonator filter. The spacing between resonators 2 and 3 was adjusted to yield a roughly equal-ripple response, and in this case, approximately 0.500 mm.

The exemplary four-resonator filter was too complex to analyze with SONNET software using the computing power presently available. Hence, instead, the value Qₑ for the external Q of the end resonators and the coupling coefficients between pairs of resonators were computed using SONNET. This was accomplished using modeled singly loaded test resonators, and also coupled pairs of test resonators. The principles used are similar to those discussed in G. L. Matthaei, L. Young, and E. M. T. Jones, “Microwave Filters, Impedance-Matching Networks, and Coupling Structures,” Norwood, Mass., Artech House (1980), Sections 11.02 and 11.04. For a given Qₑ and coupling coefficients between resonators, the approximate expected frequency response was easily computed using a simplified filter model having a half-wavelength, open-circuited shunt-stub resonators with frequency-independent inverters therebetween .

In order to get some feel as to whether the couplings between nonadjacent resonators can be ignored in the design of this structure, coupling between resonators 1 and 3, with resonators 2 and 4 removed, was computed. The computed coupling coefficient k₁₃ between resonators 1 and 3 was 0.0001696, as compared to the computed coefficient k₁₂ between resonators 1 and 2, which was 0.009483 giving k₁₃/k₁₂=1/56. Thus, the coupling coefficient k₁₃ appears to be sufficiently small compared to the coupling coefficient k₁₂, so that it can be neglected. Of course, with resonator 2 in place, the coupling coefficient k₁₃ may be somewhat different. Similar calculations between resonators 1 and 4, with resonators 2 and 3 removed, gave a coupling coefficient ratio k₁₄/k₁₂ of approximately 1/285.

FIG. 12 shows the measured passband response of this exemplary filter, with the dashed lines representing the response computed from the abovementioned simplified model using Qₑ and coupling coefficient values obtained using SONNET software, and the solid lines representing the response measured at 77° K. For easy comparison of responses, the computed response was centered on the middle of the measured response. As was also true for the two-resonator case, the measured passband ripples are larger than are the computed ripples. Again, we believe this was at least largely due to asymmetric positioning of the available dielectric tuners that had relatively large metal mounts.

As shown in FIG. 12, the measured 3-dB bandwidth is 27.27 MHz, while the 3-dB computed bandwidth was 28.18 MHz. Note that the measured response exhibits poles of attenuation on both sides of the passband due to the input and output inductive coupling taps previously mentioned. The slightly smaller measured 3-dB bandwidth as compared to the computed response is due, at least in part, to the fact that the computed response does not have adjacent poles of attenuation which would tend to narrow the passband (The simple model used for this computed response was not capable of producing those poles). Thus, it appears that the interior coupling coefficients were realized with very good accuracy, and there is no evidence of any measurable effect due to stray coupling beyond nearest neighbor resonators.

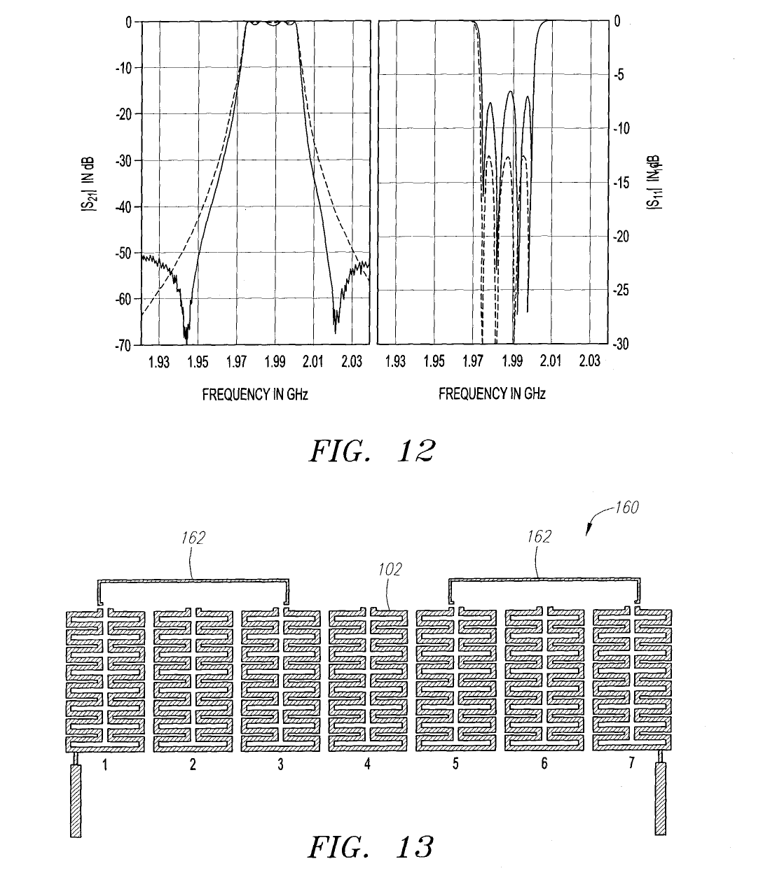

Referring now to FIG. 13, a zig-zag hairpin-comb narrow-band filter structure 160 constructed in accordance with one preferred embodiment of the present invention will now be described. The filter structure 160 is similar to the above-described two-resonator filter structure 100, with the exception that it generally comprises seven zig-zag hairpin-comb resonators 102 (numbered 1-7). Also, couplings 162 are added to non-nearest neighbor pairs of resonators 102 (in this case, the coupling between resonators 1 and 3 is accomplished by a transmission line connected with a capacitive gap at both ends while resonators 5 and 7 are similarly coupled). These couplings are included to introduce poles of attenuation beside the passband of the filter structure 160, or to alter the time-delay characteristics of the filter structure 160. The couplings 162 are unusually simple to introduce in microstrip, hairpin-comb filters. The sign (or phase) of the coupling 162 should be selected correctly, because one phase may have the effect of introducing poles of attenuation adjacent to the passband, while the other phase may primarily affect the delay characteristics of the filter structure 160. In many types of filters, it may be difficult to get the desired signs for the couplings. In the case of the filter structure 160, however, one can easily obtain either positive or negative couplings by the choice of the sides of the resonators 102 at which the coupling connection 162 is made.

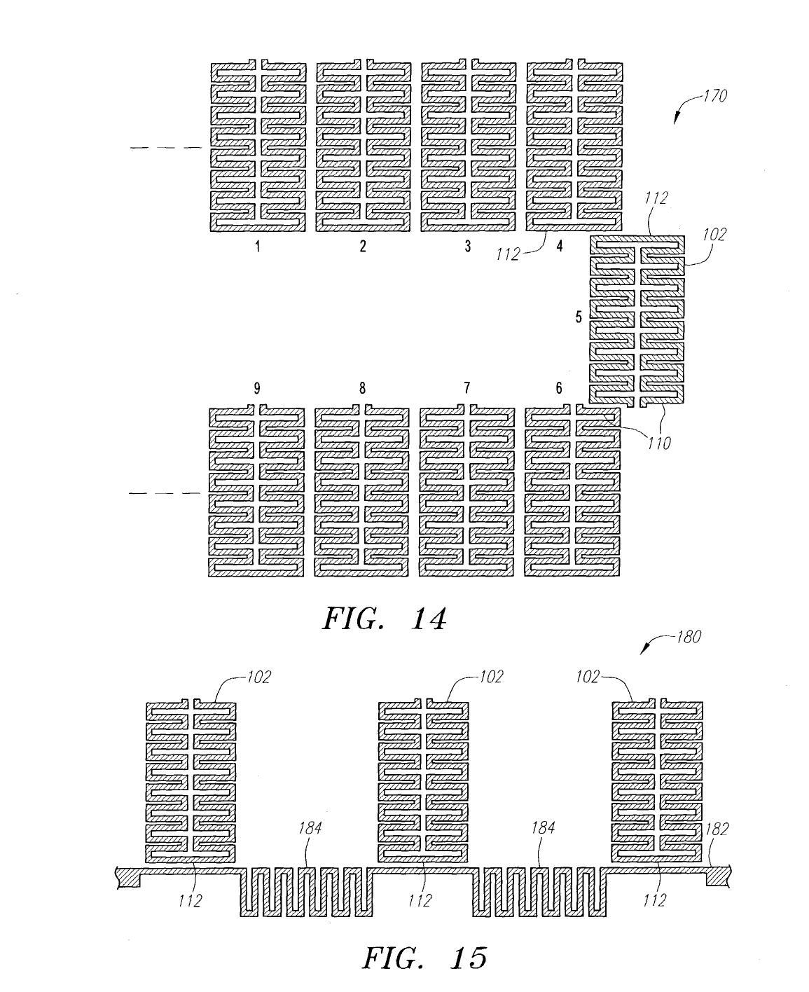

Referring now to FIG. 14, a zig-zag hairpin-comb narrow-band bandpass filter structure 170 constructed in accordance with one preferred embodiment of the present invention will now be described. The filter structure 170 is the similar to the above-described filter structure 100, with the exception that the filter structure 170 is folded to fit a large number of zig-zag hairpin-comb resonators 102 on the substrate. That is, the resonators 102 (numbered 1-9) are generally arranged into two rows rather than a single row. Notably, the resonator on the far right (resonator 5) is used for “bridging” between the two rows of resonators 102. Bridging resonator 5 has its high-current closed end 112 (at its top) adjacent to the high-current closed end 112 of resonator 4 above (at its bottom), so as to yield small inductive coupling therebetween. Similarly, bridging resonator 5 has its high-voltage open end 110 (at its bottom) adjacent to the high-voltage open end 110 of resonator 6 below (at its top), so as to yield small capacitive coupling therebetween. Preliminary calculations suggest that the bridging resonator overlap positions as illustrated in FIG. 14 should give proper coupling for filters of around 1 or 2 percent bandwidth.

The zig-zag hairpin resonators 102 described herein can also be advantageously used in narrow-band bandstop filters. Referring now to FIG. 15, a zig-zag hairpin narrow-band bandstop filter structure 180 constructed in accordance with still another preferred embodiment of the present invention is described. The bandstop filter structure 180 comprises a plurality of zig-zag hairpin resonators 102, which are spaced a quarter-wavelength apart along a transmission line 182. The closed ends 112 of the resonators 102 are inductively coupled to the transmission line 182. The transmission line 182, itself, comprises intervening quarter-wavelength line sections 184 to a create 90-degree phase shift between resonators 102. The line sections 184 are zig-zagged in order to take up less space. Alternatively, semi-lumped series inductances alternating with semi-lumped shunt capacitors can be used as the intervening transmission line sections 184. Physically, such microstrip structures would consist of short lengths of high-impedance line to approximate the series inductances, and rectangular pads to simulate the shunt capacitances. Such structures are commonly used in microstrip low-pass filters. An example of a technique for obtaining compact approximations for transmission lines can be found in G. L. Matthaei, S. M. Rohlfing, and R. J. Forse, “Design of HTS Lumped-Element, Manifold-Type Microwave Multiplexers,” IEEE Transactions on Microwave Theory and Techniques, vol. 44, no. 7, pp. 1313-1321 (July 1996), where semi-lumped elements are used to replace sizable transmission line sections between filters in manifold-type multiplexers.

Use of the zig-zag hairpin resonators 102 has an advantage in that there is relatively little coupling between the zig-zag hairpin resonators 102 for a given space between resonators 102. As a result, in many cases, the stray coupling between zig-zag hairpin resonators 102 will be sufficiently small that a satisfactory transmission response can be obtained without the complication and expense of using housings around the individual resonators 102, as may be required if more conventional microstrip resonators are used.

Thus, it can be appreciated that filters 100, 150, 160, 170, and 180 provide unusual compactness, in part, because of the zig-zag resonator lines 106, but also because the zig-zag construction is accomplished in such a way that the coupling between resonators 102 is markedly reduced, so that the resonators 102 can be placed closer together for a given desired amount of coupling. In addition, the “hairpin-comb” layout of the resonators 102 in bandpass filters causes the magnetic and electric couplings between adjacent resonators 102 to tend to cancel. This further reduces coupling between resonators 102, thus permitting still smaller coupling gaps 104. The configuration 170 of resonators 102 shown in FIG. 14 provides a convenient way of designing a filter with a very large number of resonators 102 on a single substrate. The relative small coupling between the resonators 102 for a given coupling gap 104 should make it possible in most cases to design bandpass filters by designing the couplings between two resonators at a time, while ignoring any stray couplings to non-nearest neighbor resonators. This should aid greatly in the accurate design of complex filters.

The use of zig-zag hairpin-comb bandpass filter structures (i.e., filters 100, 150, 160, and 170) provide other advantages besides being more compact and reducing the coupling, and thus spacing, therebetween. As previously discussed, there is a pole of attenuation created due to a resonance effect in the coupling gap 104 between hairpin-comb resonators 102. In the design of filters, it is sometimes desirable to move this pole of attenuation up or down in frequency. In the case of hairpin-comb filters on conventional microstrip (which has a dielectric substrate), adding “positive capacitance” between adjacent resonators near their open ends will cause this pole of attenuation to move upwards in frequency, while adding “negative capacitance” will cause this pole of attenuation to move downwards in frequency.

The use of zig-zag hairpin-comb resonators 102 provides a convenient way for moving the pole of attenuation in frequency. Specifically, the mutual capacitance between the portions of the zig-zag hairpin resonators 102 adjacent their open ends (the tops of the resonators as shown in, for example, FIG. 9(a)) can be increased or decreased relative to the mutual capacitance between the portions of the zig-zag hairpin resonators 102 adjacent their closed ends (the bottoms of the resonators) to achieve the effect of adding positive or negative capacitance. This can conveniently be accomplished by adjusting the relative lengths the non-coupling segments 118 and/or the spacings between zig-zag sections 116.

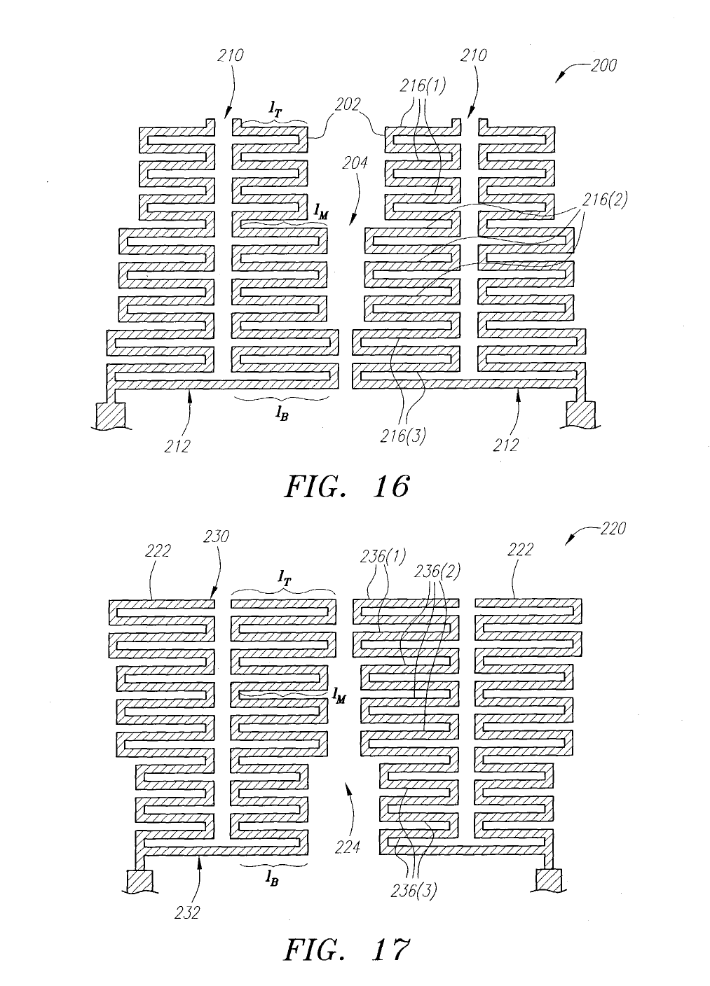

For example, FIG. 16 illustrates a zig-zag hairpin-comb narrow-band bandpass filter structure 200 that is similar to the above-described filter structure 100, with the exception that the mutual capacitance between the open ends 210 (tops) of the resonators 202 has been decreased relative to the mutual capacitance between the closed ends 212 (bottoms) of the resonators 202 to achieve an effect equivalent to adding negative mutual capacitance, thereby moving the pole of attenuation associated with the coupling gap 204 downward in frequency. Specifically, the lengths l_{T} of the zig-zag sections 216 (i.e., the lengths of the non-coupling segments) at the top of the resonators 202 have been decreased relative to the lengths l_{B} of the zig-zag sections 216 at the bottom of the resonators 202. As result, the width of the coupling gap 204 at the tops of the resonators 202 relative to the width of the coupling gap 204 at the bottoms of the resonators 202 is increased. In the illustrated embodiment, the width of the coupling gap 204 decreases in a tapering fashion from the top to the bottom of the resonators 202. Specifically, the top three zig-zag sections 216(1) have the shortest lengths l_{T}, the middle three zig-zag sections 216(2) have the next shortest lengths l_{M}, and the bottom two zig-zag sections 216(3) have the longest lengths l_{B}.

As another example, FIG. 17 illustrates a zig-zag hairpin-comb narrow-band bandpass filter structure 220 that is similar to the afore-described filter structure 100, with the exception that the mutual capacitance between the open ends 230 (tops) of the resonators 222 has been increased relative to the mutual capacitance between the closed ends 232 (bottoms) of the resonators 222 to achieve the effect of adding positive mutual capacitance, thereby moving the pole of attenuation associated with the coupling gap 224 upward in frequency. Specifically, the lengths IT of the zig-zag sections 236 at the tops of the resonators 222 (i.e., the lengths of the non-coupling segments) have been increased relative to the lengths l_{B} of the zig-zag sections 236 at the bottoms of the resonators 222. As result, the width of the coupling gap 224 at the tops of the resonators 222 relative to the width of the coupling gap 224 at the bottoms of the resonators 222 is decreased. In the illustrated embodiment, the width of the coupling gap 224 increases in a tapering fashion from the top to the bottom of the resonators 222. Specifically, the top three zig-zag sections 236(1) have the longest lengths l_{T}, the middle three zig-zag sections 236(2) have the next longest lengths l_{M}, and the bottom two zig-zag sections 236(3) have the shortest lengths l_{B}.

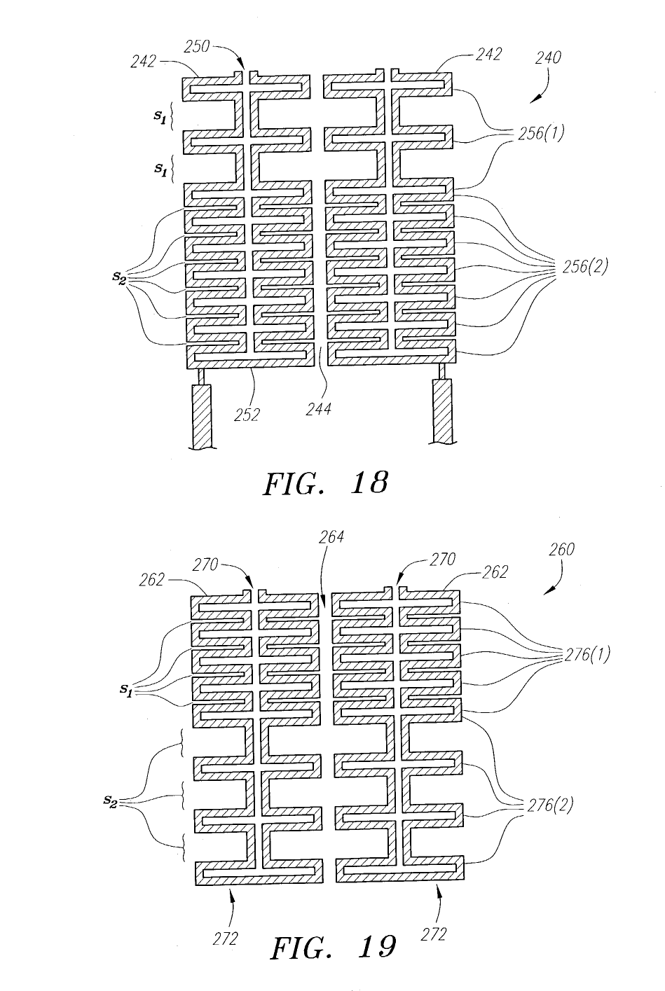

The spacing s between the zig-zag sections can also be modified in addition to or alternative to varying the lengths of the non-coupling segments forming the zig-zag sections. For example, FIG. 18 illustrates a narrow-band bandpass filter structure 240 in which the spacings s between the zig-zag sections 256 at the open ends 250 (tops) of the resonators 242 have been increased relative to the spacings S₂ between the zig-zag sections 256 at the closed ends 252 (bottoms) of the resonators 242. The spacings s are modified by altering the lengths of the interconnecting inner coupling segments 122 that connect adjacent zig-zag sections (see, e.g., FIG. 9(b)). As a result, the mutual capacitance between the top of the resonators 242 relative to the mutual capacitance between the bottom of the resonators 242 is decreased to move the pole of attenuation associated with the coupling gap 244 downward in frequency. In the illustrated embodiment, the two spacings S₁ between the top three zig-zag sections 256(1) are relatively great, while the six spacings S₂ between the bottom seven zig-zag sections 256(2) are relatively small (i.e., S₁>>S₂).

As another example, FIG. 19 illustrates a zig-zag hairpin-comb narrow-band bandpass filter structure 260 in which the spacings S₂ between the zig-zag sections 276 near the lower closed end of the resonators 260 has been increased so the net amount of coupling segments adjacent to the bottom of the coupling gap 264 has been reduced (i.e., S₂>>S₁). Since the coupling in the vicinity of the bottom (i.e., closed) ends of the resonators 262 is magnetic in nature and comes predominantly from the coupling segments adjacent to the bottom of the coupling gap 264, this has the effect of reducing the amount of magnetic coupling between the resonators. Reducing or increasing the magnetic coupling between the resonators is also a way of adjusting the frequency of the pole of attenuation associated with the coupling gap.

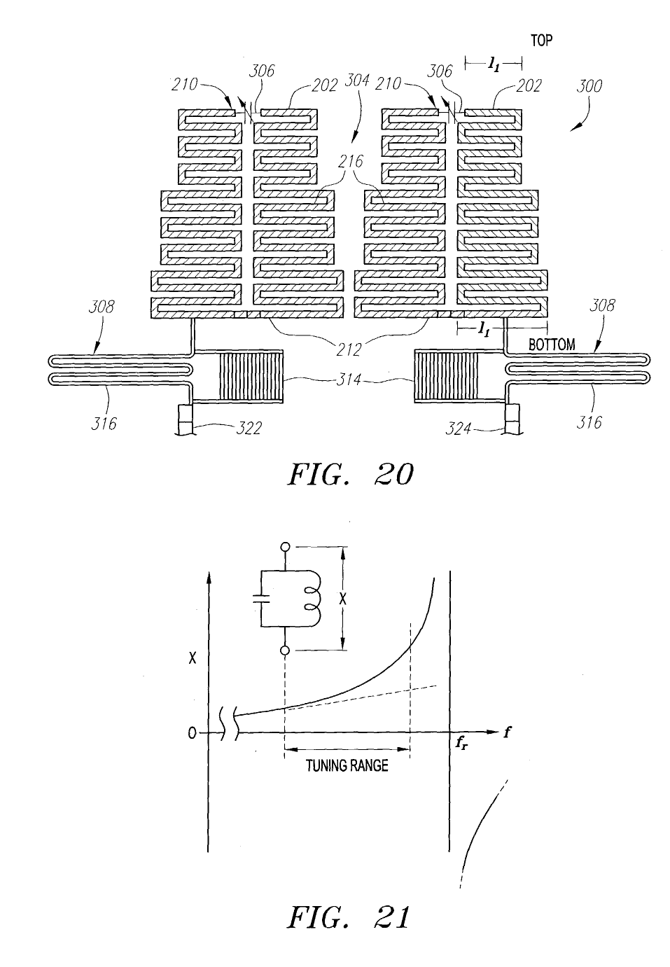

Varying the mutual capacitance between zig-zag hairpin-comb resonators lends itself well to the design of tunable bandpass filters which maintain a nearly constant bandwidth as they are tuned. Referring now to FIG. 20, a tunable zig-zag hairpin-comb narrow-band bandpass filter structure 300 constructed in accordance with another preferred embodiment of the present invention will now be described. For filters tuned by variable capacitances, unless special measures are introduced, the bandwidth always increases as the center frequency increases (instead of remaining constant as is usually desired). The tunable filter structure 300 is designed to achieve nearly constant bandwidth as it is tuned by variable capacitances. The approach used by the filter structure 300 to force nearly constant bandwidth is to introduce a pole of attenuation at an appropriate location above the tuning range of the passband. Then, as the passband is tuned up towards this pole, its influence tends to “push away” the upper edge of the passband, thus limiting the passband width.

To this end, the tunable filter structure 300 has been specially modified to, in effect, add “negative” capacitance between the resonators 202 to lower the frequency of the pole of attenuation, which otherwise would be too high in frequency to give adequate limiting of the passband width. The tunable filter structure 300 comprises the two resonators 202 illustrated in FIG. 20. A variable capacitor 306 is provided across the open end of each resonator 202 for tuning the frequency of the filter structure 300. As previously discussed, the lengths l₁ of the zig-zag sections 216 (i.e., lengths of non-coupling segments) at the open ends 210 of the resonators 202 have been decreased relative to the lengths l₁ of the zig-zag sections 216 at the closed ends 212 of the resonators 202 to achieve the effect of adding negative capacitance, so that the pole of attenuation associated with the coupling gap 304 moves downward in frequency. The shaping of the resonator zig-zags in this manner is effective for obtaining a coupling coefficient between the resonators 202 to vary with frequency so as to give a nearly constant bandwidth.

It is still desired, however, to force the external Q's of the resonators 202 to increase approximately linearly with frequency in order for the filter passband to have an acceptable shape as the filter structure 300 is tuned. In order to control the external Q vs. frequency of the resonators 202 of the filter structure 300, resonant circuits 308 are added at the input 322 and at the output 324 of the filter structure 300, as shown in FIG. 20. Each resonant circuit 308 comprises an interdigital capacitor 314 in parallel with an inductor 316 that is in the form of a meander line. This inductance and capacitance in parallel are connected to the input 322 and output 324 of the filter structure 300 so as to create a series reactance as schematically illustrated in FIG. 21. With respect to FIG. 21, as the tuning frequency moves towards the upper end of the tuning range, the reactance increases quite rapidly. Then, this reactance when connected in series with the terminations 322 and 324 tends to decouple the resonators 202 from the terminations as the frequency is increased and thus increase the external Q of the end resonators 202 as the frequency is increased.

By way of non-limiting example, an actual filter, as illustrated in FIG. 20, was designed. The composition of the filter was the same as the previous exemplary two-resonator filter. In this example, it was convenient to realize the desired L and C at the terminations by use of HTS circuitry. Having a high Q, however, is not very important for these elements, and using non-HTS lumped L's and C's external to the substrate would not have increased the loss very much. Of course, the filter techniques illustrated in FIG. 20 can also be implemented entirely in non-HTS form, but the losses would be considerably higher in that case.

In order to tune the filter for the present purposes, the variable capacitors shown in FIG. 20 were replaced by fairly lengthy HTS interdigital capacitors, which were photoetched on the substrate along with the rest of the circuit. The passband was tuned to higher frequencies by scribing away portions of the interdigital capacitors to gradually reduce the tuning capacitances. With the complete interdigital capacitances in place, the filter tuned to a center frequency of 498 MHz.

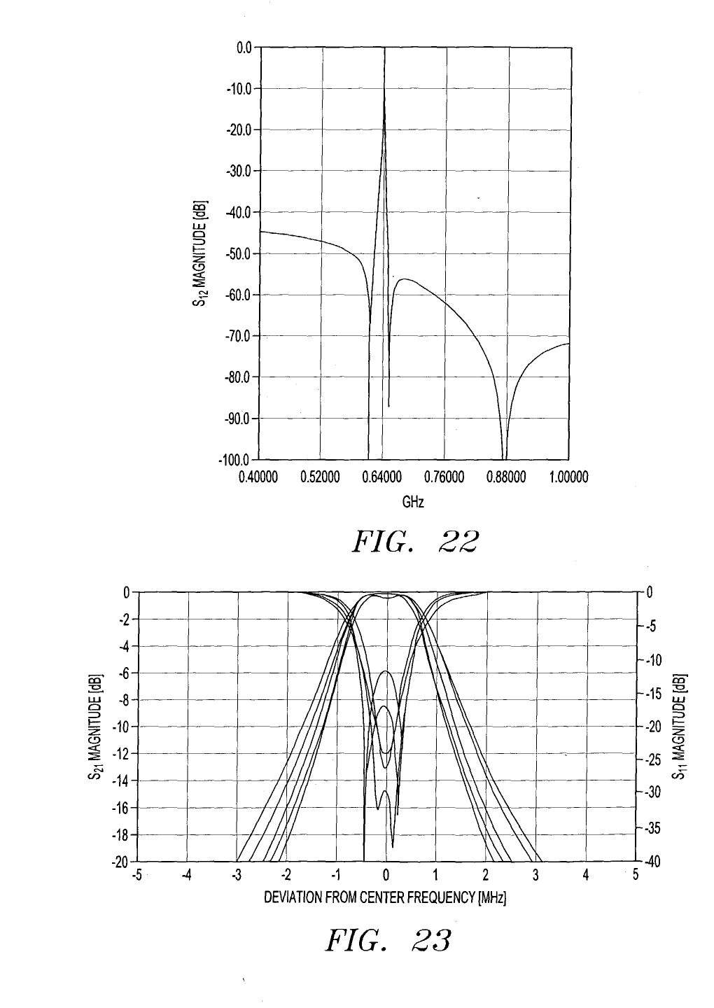

FIG. 22 shows the computed response of this exemplary filter when tuned to 640 MHz. Note the poles of attenuation on both sides of the passband. These are due to the tap connections on the end resonators, as was discussed previously. These poles of attenuation move along with the passband as it is tuned. The pole of attenuation at about 880 MHz is the one that is used to limit the passband width as the filter is tuned to higher frequencies. Over most of the tuning range, the frequency of the pole moves relatively little as the passband is swept.

From FIG. 22, one might expect that this filter could only be tuned as far up as some frequency below 880 MHz. Surprisingly enough, however, that is not the case, and the filter was successfully tuned well above 880 MHz. As the passband moves up towards the pole, it turns out that the pole gradually moves upward also. At the upper end of the tuning range, the pole was still above the passband though relatively close to it. With the interdigital tuning capacitors totally scribed away, a passband frequency of 948 MHz was measured-still with reasonably good passband width and shape.

FIG. 23 shows a superposition of the measured passband responses obtained at various frequencies (498, 555, 634, 754, and 948 MHz) as portions of the tuning capacitors were scribed away. For practical engineering purposes, the passband shape and width remained remarkably constant over this 498 MHz to 948 MHz range (nearly an octave). Resonator unloaded Q measurements were made at 77K, and the Q's were determined to be in the 85,000 to 90,000 range at 948 MHz.

For many practical applications, it would be desirable to use tunable MEMS capacitors with filters of this sort, so that the filters could be tuned electronically. Filters with interdigital tuning capacitors, such as in the exemplary filter may also have practical application where filters having a certain bandwidth are needed for a number of different center frequencies. Several filters could be fabricated at the same time and afterwards, each circuit scribed to give its desired center frequency. Alternatively, instead of interdigital capacitors etched on the surface of the substrate, resonators can simply be attached to small parallel-plate capacitors made from thin slabs of dielectric with conducting material deposited on the top and bottom surfaces.

The preferred embodiments discussed herein were HTS microstrip filter structures. The techniques discussed herein, however, can also be applied to non-HTS filters, and the filter structures need not necessarily be in microstrip. The same general concepts can also be utilized in other planar structures such as stripline and suspended stripline. If the filter structure has a homogenous dielectric, however, the effect of adding positive or negative coupling capacitance will be reversed from that described for the microstrip case. For example, for the case of stripline with homogeneous dielectric, the pole of attenuation associated with the coupling gap will move down in frequency if positive capacitance is added, and move upward in frequency of a negative capacitance is added.

Although particular embodiments of the present invention have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A zig-zag hairpin-comb narrow-band bandpass filter, comprising:
a plurality of side-coupled zig-zag hairpin-comb resonators, each of the zig-zag hairpin-comb resonators comprising a pair of neighboring legs forming an open end and a closed end, the neighboring legs of adjacent zig-zag hairpin-comb resonators straddling a respective coupling gap, at least a portion of each of the neighboring legs from adjacent zig-zag hairpin-comb resonators formed with zig-zag sections; and
wherein each of the plurality of zig-zag hairpin-comb resonators are oriented with their respective open ends in the same direction.

2. The filter of claim 1, wherein the neighboring pair of legs of each zig-zag hairpin-comb resonator has zig-zag sections.

3. The filter of claim 1, wherein each of the zig-zag sections comprise a pair of non-coupling segments that are perpendicular to a respective one of the one or more coupling gaps, and an interconnecting outer coupling segment that extends parallel and adjacent to the respective coupling gap.

4. The filter of claim 1, further comprising:
an input coupled to a first one of said plurality of zig-zag hairpin-comb resonators; and
an output coupled to a last one of said plurality of zig-zag hairpin-comb resonators.

5. The filter of claim 1, wherein the zig-zag hairpin-comb resonators are planar structures.

6. The filter of claim 1, wherein the zig-zag hairpin-comb resonators are microstrip resonators.

7. The filter of claim 1, wherein the zig-zag hairpin-comb resonators are fabricated using HTS material.

8. The filter of claim 1, wherein each of the plurality of zig-zag hairpin-comb resonators has a nominal linear length of a half wavelength at the resonant frequency.

9. The filter of claim 1, wherein all of the zig-zag hairpin-comb resonators are arranged in a single row.

10. The filter of claim 1, wherein the plurality of zig-zag hairpin-comb resonators is arranged in a plurality of rows with one or more bridging resonators coupling the zig-zag hairpin-comb resonator rows.

11. The filter of claim 1, further comprising one or more capacitive couplings that are coupled between one or more pairs of the plurality of zig-zag hairpin-comb resonators.

12. The filter of claim 11, wherein the one or more capacitive couplings are connected between non-neighboring zig-zag hairpin-comb resonators.

13. The filter of claim 11, wherein the capacitive couplings comprise a transmission line with capacitive gaps at its ends disposed adjacent to the open ends of two of the plurality of zig-zag hairpin-comb resonators.

14. The filter of claim 1, wherein each of the one or more coupling gaps between resonators are substantially uniform in width.

15. The filter of claim 1, wherein each of the one or more coupling gaps between resonators are substantially non-uniform in width.

16. The filter of claim 1, wherein the width of at least one coupling gap formed between adjacent zig-zag hairpin-comb resonators increases in the direction towards the open end of said adjacent zig-zag hairpin-comb resonators.

17. The filter of claim 1, wherein the width of at least one coupling gap formed between adjacent zig-zag hairpin-comb resonators decreases in the direction towards the open end of said adjacent zig-zag hairpin-comb resonators.

18. The filter of claim 1, wherein the zig-zag sections nearest to the closed ends of the zig-zag hairpin-comb resonators are spaced together more closely than the zig-zag sections farthest from the closed ends of the zig-zag hairpin-comb resonators.

19. The filter of claim 1, wherein the zig-zag sections nearest to the open ends of the zig-zag hairpin-comb resonators are spaced together more closely than the zig-zag sections farthest from the open ends of the zig-zag hairpin-comb resonators.

20. A zig-zag hairpin narrow-band bandstop filter comprising:
a plurality of zig-zag hairpin resonators disposed adjacent to a main transmission line at intervals of a quarter wavelength with the closed end of the resonators adjacent to the main line so as to provide magnetic couplings between the main transmission line and the resonators.

21. The filter of claim 20, wherein the transmission line comprises intervening quarter-wavelength zig-zagged line sections.

22. The filter of claim 20, wherein the transmission line comprises intervening semi-lumped series inductances alternating with semi-lumped shunt capacitors.

23. The filter of claim 22, wherein the semi-lumped series inductances comprise a short length of high-impedence line.

24. The filter of claim 22, wherein the semi-lumped shunt capacitors comprise rectangular pads.

25. A tunable zig-zag hairpin-comb narrow-band bandpass filter comprising:
a plurality of side-coupled zig-zag hairpin-comb resonators, each of the zig-zag hairpin-comb resonators comprising a pair of neighboring legs forming an open end and a closed end, the neighboring legs of adjacent zig-zag hairpin-comb resonators straddling a respective coupling gap, at least a portion of each of the neighboring legs from adjacent zig-zag hairpin-comb resonators formed with zig-zag sections, wherein each of the plurality of zig-zag hairpin-comb resonators are oriented with their respective open ends in the same direction, and wherein the respective coupling gap increases in width in the direction of the open end of the zig-zag hairpin-comb resonators;
a variable capacitor provided across the open end of each of the plurality of zig-zag hairpin-comb resonators;
an input coupled to one of the plurality of zig-zag hairpin-comb resonators;
an ouput coupled to one of the plurality of zig-zag hairpin-comb resonators; and
a resonant circuit connected to each of the input and output.

26. The filter of claim 25, wherein the resonant circuit comprises an interdigital capacitor in parallel with an inductor.

27. The filter of claim 26, wherein the inductor comprises a meander line.

28. The filter of claim 25, wherein the variable capacitors comprise HTS interdigital capacitors.

29. The filter of claim 25, wherein the variable capacitors comprise tunable MEMS capacitors.

30. The filter of claim 25, wherein the variable capacitors comprise parallel-plate capacitors.
